(19) United States
(12) Patent Application Publication
(10) Pub. No.: US 2026/0139822 A1
(43) Pub. Date: May 21, 2026

(54) ADJUSTABLE CONNECTOR

(71) Applicant: Dorcy International, Inc., Columbus, OH (US)

(72) Inventor: Yau Wai Chee, Jeiyang City (CN)

(21) Appl. No.: 19/310,501

(22) Filed: Aug. 26, 2025

(30) Foreign Application Priority Data
Nov. 15, 2024 (CN) 2024227908781

(51) Int. Cl. F21V 23/06; F21L 4/08; H01R 13/44; H01R 13/629

(52) U.S. Cl. CPC F21V 23/06; F21L 4/08; H01R 13/44; H01R 13/629

(57) ABSTRACT

An apparatus such as a battery powered light includes a housing, a component in the housing; and a connector electrically connected to the component, the connector rotatable relative to the housing about a first axis, allowing adjustment of an orientation of the connector relative to the housing in a first degree of freedom.

### RELATED APPLICATIONS

This patent application claims priority to and the benefit of the filing date of Chinese patent application serial number 2024227908781, filed Nov. 15, 2024 for “An Electrical Product with Rotatary Recharging mechanism,” the entire contents of which are hereby incorporated by this reference.

### RELATED FIELDS

Electronic products, such as electronic products including adjustable connectors, including rotatable charging structure for the electronic product.

### BACKGROUND

Universal Serial Bus (USB) is a serial bus standard, and also a technical specification for input and output interfaces, because the USB interface supports the plug-and-play and hot-swappable functions of the device. More and more electronic products choose USB structure as the connection interface, USB structure is widely used in personal computers and mobile devices and other information and communication products, and extended to photographic equipment, digital TV, game consoles and other related fields.

In some instances, due to the different shapes of various electronic products, it is often encountered that electronic products can only be smoothly connected when they are turned to a certain angle. However, because the charging interface is usually fixed on the electronic product, when the electronic product rotates, the charging interface will also rotate, which will cause the charging interface to be unable to be inserted into the corresponding interface, and the electronic product cannot be used in specific scenarios.

### SUMMARY

We have developed an improved, adjustable connector, such as may be usable to provide a rotatable charging structure for electronic products and for similar uses. In some examples, when this rotatable charging structure is in use, the charging interface can be rotated according to demand, so that it is suitable for various different use scenarios, and can guarantee that the connection line does not appear twisted when the charging interface rotates.

In one particular example, the rotatable charging structure for the electronic product includes the shell and the charging interface of the electronic product, and also includes a rotating seat. The rotating seat may be rotatably mounted on the housing, the charging interface is arranged on the rotating seat, and the charging interface is directly electrically connected with the circuit of the electronic product through a line. Between the rotating seat and the shell, there may also be provided a limiting mechanism that can limit the rotation amplitude of the rotating seat.

In some implementations, when the above-mentioned rotatable charging structure is in use, according to the size of the space at the required plug-in position and the orientation of the required use position of the electronic product, the charging interface is rotated through the rotating base, so that the charging interface is within the range of a limited angle. In this manner, rotation at various angles may be realized. When this rotatable charging structure is used, the charging interface can be rotated relative to electronic products, and will not be affected by various rotation angles of electronic products, so that it can be applied to various scenarios; At the same time, the charging interface can be arbitrarily rotated only within the limited angle range under the effect of the limiting mechanism, in this range, the charging interface can be matched with the rotation angle of the electronic product, and the line between the charging interface and the circuit of the electronic product will not appear twisted again, and the situation that the line interface will not be disconnected, so the connection between the charging interface and the circuit of the electronic product does not need other follow-up adapters, and the circuit of the electronic product can be directly connected with the circuit of the electronic product through the line.

In one particular implementation, the limiting mechanism may include a first limiting block and at least one second limiting block, the first limiting block being arranged on the rotating seat, and the second limiting block being arranged in the shell and is on the motion trajectory of the first limiting block. When the number of the second limiting blocks is one, the rotating seat can rotate in the range of 0-360°, but the situation that the line is twisted due to the infinite rotation of more than 360° does not occur. When the number of the second limiting blocks is two, under the restriction of the two second limiting blocks, when the rotating seat rotates a certain angle, the first limiting block will be in contact with the second limiting block, and the rotating seat cannot continue to rotate past this point, and through this setting, the rotating seat can be made to rotate only within the range of the limited angle.

In another particular implementation, the number of the second limiting blocks is two, the center of rotation of the rotating seat is the center of the circle, and the central angle between the two second limiting blocks is 90 degrees. A rotation range of 0-90° may be suitable for several applications.

In some implementations, the shell is provided with a first through hole matched with the rotating seat, the rotating seat can be rotatably installed in the first through hole of the housing, and the upper surface of the rotating seat is flush with the upper surface of the housing.

In another particular implementation, the rotatable charging structure further includes a flipping piece, the flipping piece is rotatably arranged on the rotating seat, and the charging interface is arranged on the flipping piece. A notch is formed on the rotating seat, and the shell is provided with a first groove corresponding to the notch, the first groove is connected with the first through hole, the notch matches the shape of the flipping piece, and the first groove matches the shape of the charging interface. When not in use, the flip piece can be flipped, and the flip piece and the charging interface are hidden in the notch and the first groove; When it needs to be used, the flipping piece can be flipped up to make the charging port stand up.

In implementations including a rotating seat and a flipping piece, and in other implementations, the adjustable connector may allow adjustment about at least two degrees of freedom. The connector may rotate (e.g. using a rotating seat) about a first axis and may rotate (e.g. using a flipping piece) about a second axis. In some instances, the first and second axes may be non-parallel, such as but not limited to orthogonal. In still other implementations, an adjustable connector may be included in a electronic product with a flipping piece without using a rotatable seat, or may otherwise only be adjustable about one degree of freedom (such as allowing flipping out and flipping in of the connector, but not other types of rotational adjustment).

In some implementations, the two ends of the flipping piece are provided with rotating shafts. The rotating seat includes corresponding apertures, formed by grooves in the first and second rotating discs. The first rotating disc is detachably connected with the second rotating disc, and the flipping piece is rotatably clamped between the first rotating disc and the second rotating disc, with the rotating shafts captured in the apertures, yet still able to rotate. The connector may be electrically connected to the circuit of the electronic product through a cable hole in the flipping piece. The connection mode of the first rotating disc and the second rotating disc can be connected with the positioning column and the positioning hole, and can also be connected with the spline and the spline hole, and can also be locked directly by using the bolt.

In this particular example, the lower part of the side of the second rotating disc is provided with a convex edge extending outward, the second rotating disc exposes the outside of the shell through the first through hole, and the convex edge is in contact with the inner wall surface of the shell; Described first limiting block is arranged on convex edge. When installing the rotating seat, the second rotating disc can be directly exposed from the inside of the housing by the first through hole, and the rotating seat can not continue to stretch out from the first through hole under the restriction of the convex edge at this moment. Usually, the swivel seat can also be connected to the housing by means of a hinge.

In some implementations, the charging interface is a USB-A interface or a USB-C interface. In other implementations, the charging interface is another type of interface or, in still other implementations, another type of electrical connector may be used rather than a charging interface.

In the above described examples, one of the beneficial effects is that: when this rotatable charging structure is in use, the charging interface can be rotated according to the need, so that it is suitable for various different use scenarios, and can guarantee that the connection line does not appear twisted when the charging interface rotates.

### BRIEF DESCRIPTION OF FIGURES

FIG. 1 is an example of a rotatable charging structure incorporated into an electronic product.

FIG. 2 is a schematic diagram of the structure of the first rotating disc in the rotatable charging structure of FIG. 1.

FIG. 3 is a schematic diagram of the structure of the second rotating disc in the rotatable charging structure of FIG. 1.

FIG. 4 is a schematic diagram of the structure of the flipping part in the rotatable charging structure of FIG. 1.

FIG. 5 is a schematic diagram of a battery powered light.

FIG. 6 is an additional view of the rotatable charging structure of FIGS. 1-4.

### DETAILED DESCRIPTION

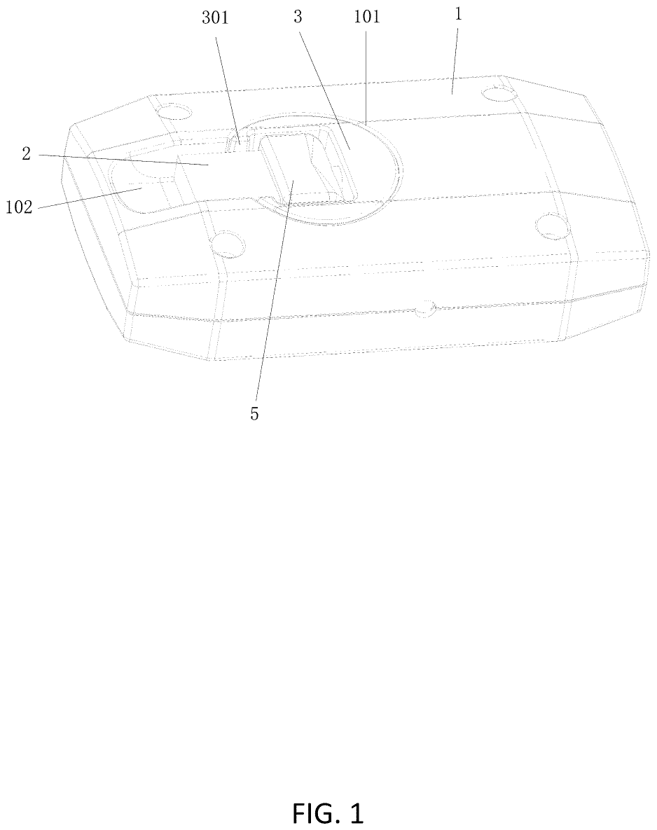

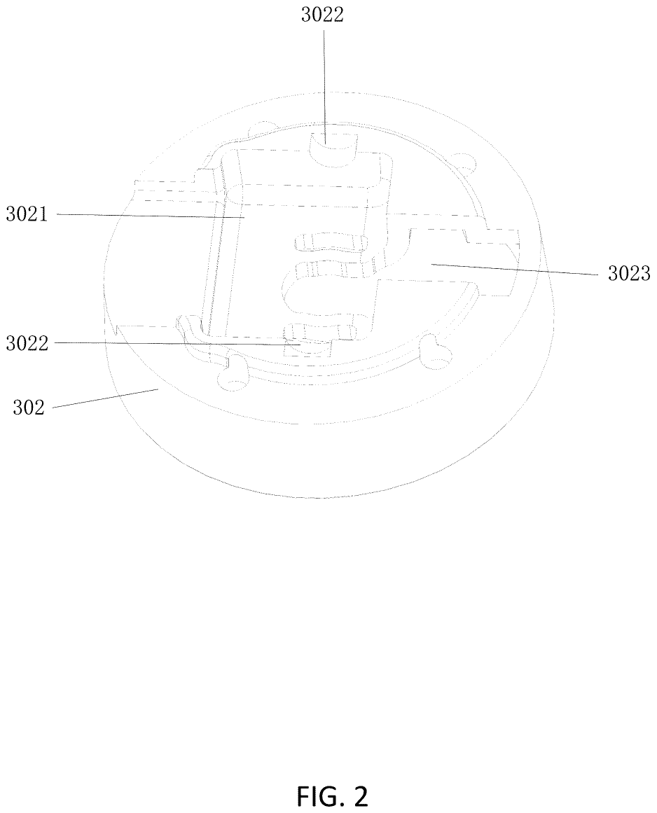

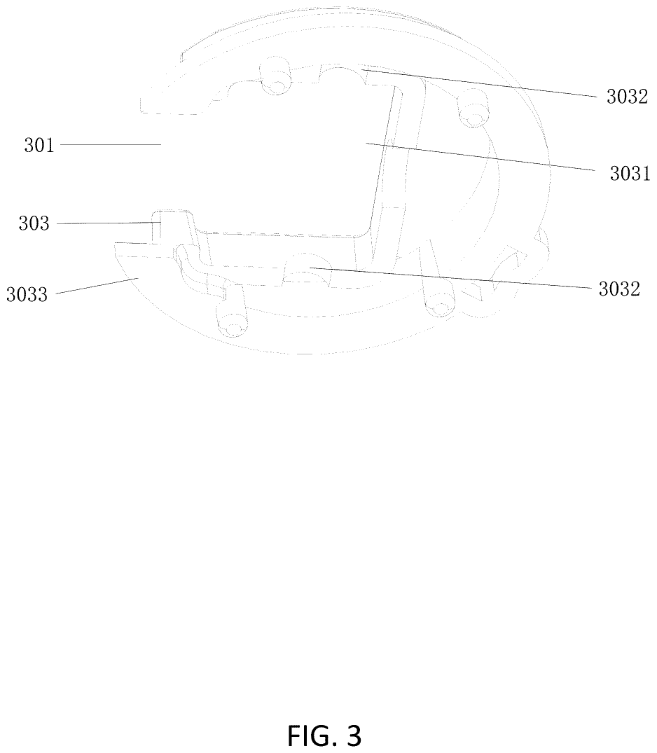

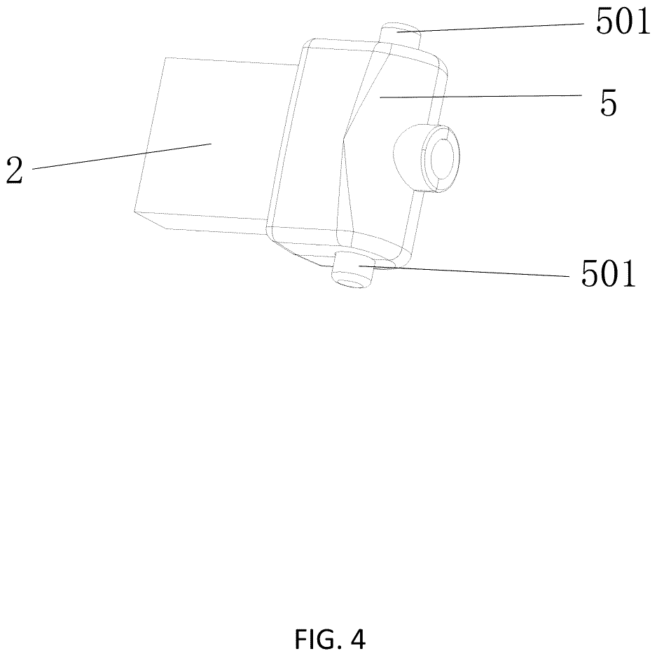

FIGS. 1-4 and 6 show an example of an apparatus, in this example an electronic product (more particularly, a battery powered light). The electronic product in this example includes a rotatable charging structure as shown in FIGS. 1-4. The rotatable charging structure includes a housing (e.g. shell 1), a component in the housing (e.g. a battery or circuitry not shown), a connector electrically connected to the component (e.g. a charging interface 2), and a rotating platform (e.g. rotating seat 3). The charging interface 2 is arranged on the rotating seat 3, and the charging interface 2 is directly electrically connected with the circuit or battery of the electronic product through a flexible write (e.g. a line (not shown)). Between the rotating seat 3 and the shell 1, a stop (e.g. a limiting mechanism) can limit the rotation amplitude of the rotating seat 3.

In this example, when the rotatable charging structure is in use, according to the size of the space at the required plug-in position and the orientation of the required use position of the electronic product, rotation through the rotating seat 3 allows the charging interface 2 to realize various orientations of the connector within a rotational range. When this rotatable charging structure is in use, the charging interface 2 can be rotated relative to the electronic product, and will not be affected by various different rotation angles of the electronic product, so that it can be applied to various scenes. At the same time, in at least some implementations, the charging interface 2 can also be rotated arbitrarily only within the limited angle range under the effect of the limiting mechanism 4. In this range, the charging interface 2 can be guaranteed to match the rotation angle of the electronic product, and the line between the charging interface 2 and the circuit of the electronic product will not appear twisted again, and the situation that the line interface will not be disconnected, so the connection between the charging interface 2 and the circuit of the electronic product does not need other follow-up adapters, and the circuit of the electronic product can be directly connected with the circuit of the electronic product through the line.

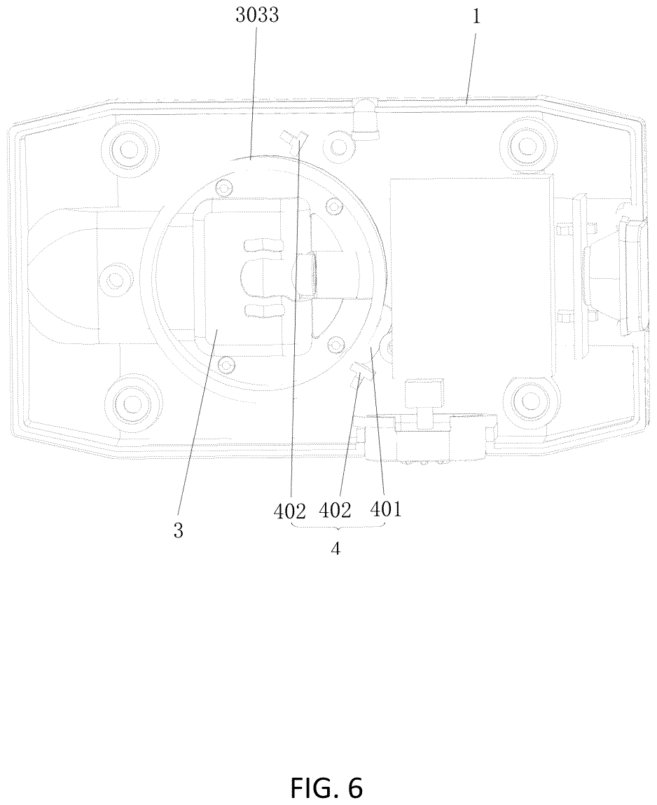

As shown in FIG. 6, in this example the limiting mechanism 4 includes a first limiting block 401 and two second limiting blocks 402, the first limiting block 401 is arranged on the rotating seat 3, the two second limiting blocks 402 are respectively arranged in the shell 1 and are on the motion trajectory of the first limiting block 401, the center of rotation of the rotating seat 3 is the center of the circle, and the central angle between the two second limiting blocks 402 is 90°. Under the restriction of the two second limiting blocks 402, when the rotating seat 3 rotates a certain angle, the first limiting block 401 will be in contact with the second limiting block 402, the rotating seat 3 cannot continue to rotate at this moment, and through this arrangement, the rotating seat 3 can be made to rotate only within the range of the limited angle. In general, the charging port 2 only needs to be rotated arbitrarily in the range of 0-90° to meet the needs of various scenarios.

In this example the shell 1 is provided with a first through hole 101 matched with the rotating seat 3, the rotating seat 3 is rotatably installed in the first through hole 101 of the housing 1, and the upper surface of the rotating seat 3 is flush with the upper surface of the housing 1.

In this example the rotatable charging structure further includes a flip piece 5, the flip piece 5 is rotatably arranged on the rotating seat 3, and the charging interface 2 is arranged on the flip piece 5. A notch 301 is formed on the rotating seat 3, a first groove 102 corresponding to the notch 301 is arranged on the shell 1, the first groove 102 is connected with the first through hole 101, the notch 301 matches the shape of the flip piece 5, and the first groove 102 matches the shape of the charging interface 2. When not in use, the flip piece 5 can be flipped, and the flip piece 5 and the charging interface 2 are hidden in the notch 301 and the first groove 102; When need to use, the flip piece 5 can be turned over to make the charging interface 2 stand up.

In this example the two ends of the flip piece 5 are provided with rotating shafts 501. The rotating seat 3 includes a first rotating disc 302 and a second rotating disc 303, a second groove 3021 and two third grooves 3022 are arranged on the first rotating disc 3022, the second groove 3021 is matched with the flip piece 5, and the groove bottom of the second groove 3021 is provided with a threading hole 3023; the two third grooves 3022 are respectively positioned at two sides of the second groove 3021, and the third groove 3022 is matched with the rotating shaft 501 of the flipping piece 5. The second rotating disc 303 is provided with a second through hole 3031 matched with the second groove 3021, and the notch 101 is formed on the second rotating disc 303 and is connected with the second through hole 3031; the lower surface of the second rotating disc 303 is provided with two fourth grooves 3032, and the fourth groove 3032 corresponds one-to-one with the third groove 3022; the first rotating disc 302 is detachably connected with the second rotating disc 303, and the turning piece 5 is arranged between the first rotating disc 302 and the second rotating disc 303 through a rotating shaft 501 rotatable clamp; The first limiting block 401 is arranged on the outside of the first rotating disc 302 or the second rotating disc 303. When installing the flip piece 5, the flip piece 5 is first placed in the second groove 3021 of the first rotating disc 302, and the two rotating shafts 501 are respectively in the two third grooves 3022; Subsequently, the second rotating disc 303 is covered on the second rotating disc 303, the two rotating shafts 501 are between the third groove 3022 and the fourth groove 3032 at this moment, and the flipping piece 5 can be exposed through the second through hole 3031, and the flipping piece 5 can be freely flipped through the rotating shaft 501. The circuit can connect the charging interface 2 with the circuit of the electronic product through the threading hole. The connection mode of the first rotating disc 302 and the second rotating disc 303 adopts the mode of positioning column and positioning hole connection.

Continuing with this example, the lower part of the side of the second rotating disc 303 is provided with a convex edge 3033 extending outward, the second rotating disc 303 exposes the outside of the shell 1 through the first through hole 101, and the convex edge 3033 is in contact with the inner wall surface of the shell 1; As shown in FIG. 6, the first limiting block 401 is arranged on the protruding edge 3033. When the rotating seat 3 is installed, the second rotating disc 303 can be directly exposed from the inside of the housing 1 by the first through hole 101, and the rotating seat 3 can no longer extend from the first through hole 101 under the restriction of the convex edge 3033.

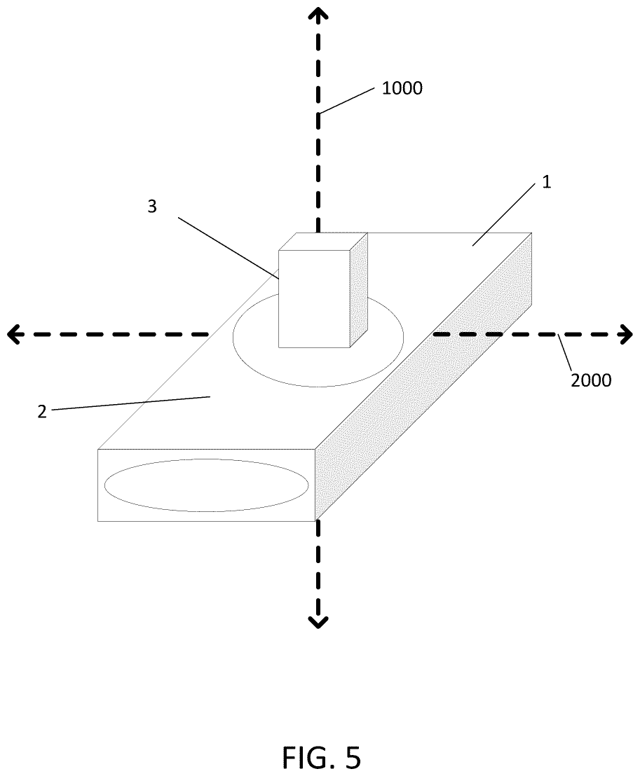

FIG. 5 is another example of an apparatus (more particularly a battery powered light) illustrating the degrees of freedom in which the orientation of the connector 2 can be adjusted. In FIG. 5 the rotating platform 3 is rotatable relative to the housing 1 about axis 1000, allowing adjustment of the orientation of the connector 2 relative to the housing 1 in a first degree of freedom. In the example of FIG. 5, axis 1000 is perpendicular to the face of the housing 1 in which the rotating platform 3 is located. Continuing with this example, the connector 2 is mounted in the rotating platform 3 in a pivoting fashion, such that connector 2 is rotatable relative to the housing 1 about axis 2000 allowing adjustment of the orientation of the connector 2 relative to the housing 1 in a second degree of freedom. In this example, axis 2000 is perpendicular to axis 1000. In this example, the connector 3 is shown in a deployed configuration.

1. An apparatus comprising:
(a) a housing;
(b) a component in the housing; and
(c) a connector electrically connected to the component, the connector rotatable relative to the housing about a first axis, allowing adjustment of an orientation of the connector relative to the housing in a first degree of freedom.

2. The apparatus of claim 1 wherein the connector is rotatable relative to the housing about a second axis that is different from the first axis, allowing adjustment of the orientation of the connector in a second degree of freedom.

3. The apparatus of claim 2 wherein the connector is rotatable relative to the housing about the second axis between a retracted configuration and a deployed configuration.

4. The apparatus of claim 3 wherein the connector is rotatable relative to the housing about the first axis when the connector is in the deployed configuration, allowing the adjustment of the orientation of the connector in the second degree of freedom while the connector is in the deployed configuration.

5. The apparatus of claim 3 wherein, when in the retracted configuration, the connector is recessed into the housing, and wherein, when in the deployed configuration, the connector extends away from the housing.

6. The apparatus of claim 2 wherein the connector is mounted in a flipping part and the flipping part is mounted in a rotating platform, wherein the flipping part is rotatable relative to the rotating platform, wherein the rotating platform is rotatable relative to the housing.

7. The apparatus of claim 6 wherein the rotating platform comprises a recess, and wherein, when the connector is in the retracted configuration, the connector is in the recess.

8. The apparatus of claim 2 wherein the first axis is perpendicular to a face of the housing and wherein the second axis is parallel to the face of the housing.

9. The apparatus of claim 2 wherein the connector is a USB connector.

10. The apparatus of claim 1 wherein the connector is rotatable relative to the housing about the first axis by no more than 360 degrees.

11. The apparatus of claim 10 further comprising at least one stop arranged to limit the rotation of the connector relative to the housing about the first axis.

12. The apparatus of claim 11 further comprising a second stop, the at least one stop defining a first maximum rotational orientation and the second stop defining a second maximum rotational orientation.

13. The apparatus of claim 11 comprising at least one flexible wire electrically connecting the connector to the component.

14. A battery powered light comprising:
(a) a housing;
(b) a battery in the housing; and
(c) a light in the housing, the battery arranged to provide power to the light; and
(d) a connector arranged to charge the battery, the connector rotatable relative to the housing about a first axis, allowing adjustment of an orientation of the connector relative to the housing in a first degree of freedom.

15. The battery powered light of claim 14 wherein the connector is rotatable relative to the housing about a second axis that is different from the first axis, allowing adjustment of the orientation of the connector in a second degree of freedom.

16. The battery powered light of claim 15 wherein the connector is mounted in a flipping part and the flipping part is mounted in a rotating platform, wherein the flipping part is rotatable relative to the rotating platform, wherein the rotating platform is rotatable relative to the housing.

17. The battery powered light of claim 14 wherein the connector is rotatable relative to the housing about the first axis by no more than 360 degrees.

18. The battery powered light of claim 17 further comprising at least one stop arranged to limit the rotation of the connector relative to the housing about the first axis.

19. The battery powered light of claim 18 further comprising at least one flexible wire electrically connecting the connector to the battery.
